(19) United States
(12) Patent Application Publication
(10) Pub. No.: US 2026/0022034 A1
(43) Pub. Date: Jan. 22, 2026

(54) TOOLS & METHODS FOR PORTABLE NEAR WELLHEAD DIRECT CO2 CONVERSION INTO METHANOL USING LASER REDUCTION IN LIQUIDS (LRL) METHOD

(71) Applicant: SAUDI ARABIAN OIL COMPANY, Dhahran (SA)

(72) Inventors: Safiyah Fayez ALGHAMDI, Dhahran (SA); Abeer Ateeq ALARAWI, Dhahran (SA)

(73) Assignee: SAUDI ARABIAN OIL COMPANY, Dhahran (SA)

(21) Appl. No.: 18/779,812

(22) Filed: Jul. 22, 2024

(51) Int. Cl. C02F 1/30; B01J 27/057; B01J 35/39; C02F 1/70; C02F 101/10; C02F 103/36; E21B 43/26

(52) U.S. Cl. CPC C02F 1/30; B01J 27/0576; B01J 35/39; C02F 1/70; C02F 2101/10; C02F 2103/365; E21B 43/2607

(57) ABSTRACT

A system for mitigating pollution from hydraulic fracturing uses a laser reduction liquid (LRL) unit operable to receive flow back from a wellhead. The LRL unit includes a CO₂ filtration unit for filtering CO₂ from the flow back, a CO₂ purification unit for purifying the filtered CO₂, and a reaction unit including Q-driven ND:YAG laser and a reaction site at which a pulsed laser beam from the Q-driven ND:YAG laser is directed at the purified CO₂ in the presence of a photocatalyst to thereby convert the CO₂ into methanol and water.

### FIELD OF THE DISCLOSURE

The present disclosure relates generally to mitigating adverse effects of hydraulic fracturing, and more particularly, to converting the CO₂ product thereof into methanol using laser reduction in liquids.

### BACKGROUND OF THE DISCLOSURE

Oil and gas operations contribute to direct carbon dioxide (CO₂) emissions through various processes, including the combustion of natural gas, venting, flaring, and the release of CO₂-rich formation fluids. These emissions can occur at the wellhead and are detrimental to the environment, as CO₂ is a significant greenhouse gas that contributes to climate change. Additionally, CO₂ can be produced during hydraulic fracturing flowback, a process where the fracturing fluid returns to the surface after stimulating the well. The flowback fluid may contain dissolved CO₂ from the reservoir and CO₂ generated during the fracturing process. The intentional release of gases during venting and flaring not only wastes valuable resources but also exacerbates the global warming effect. The negative aspects of these direct CO₂ emissions highlight the urgent need for improved technology to minimize the environmental impact and address the broader concerns of climate change and sustainability in the oil and gas industry.

There is a need to reduce CO2 emissions that improves upon conventional conversion methods that traditionally rely on chemical reactions, which raise concerns about their economic and environmental impact due to hazards related to resultant by product for example.

In literature, there has been extensive research on CO₂ conversion using dispersed light such as light emitting diodes devices (LEDs). When compared to lasers, LEDs can be disadvantageous due for example to their delivering less light intensity which directly affects the efficiency of the photochemical reaction. The number of absorbed photons (N_{abs}) in a photochemical reaction is directly proportional to the light intensity according to the Beer-Lambert Law:

$$I = {I}_{0} {e}^{- ε c l}$$

Where:
(I) is the transmitted light intensity.
(I₀) is the incident light intensity.
(ε) is the molar absorptivity or absorption coefficient.
(c) is the concentration of the absorbing species.
(l) is the path length of the sample.

When comparing lasers to LEDs, lasers typically emit light with much higher intensity. This heightened intensity implies that a greater number of photons is delivered per unit of time. As a result, the light-absorbing molecules in the photochemical reaction encounter a more substantial photon flux. This implies a more efficient conversion of photons into the desired products, ultimately resulting in higher photochemical efficiency.

There is a need to apply to flowback a portable laser-based direct CO₂ reduction system to produce methanol as an end product. Producing methanol through CO₂ reduction represents a multifaceted solution at the intersection of environmental sustainability, energy innovation, and economic viability. This approach not only helps counteract carbon emissions but also establishes methanol as a renewable energy carrier and chemical feedstock.

Economically, methanol's versatile applications, such as a fuel or chemical precursor, hold potential to reshape industries and create additional revenue streams. With uses spanning from transportation fuel and renewable energy storage to plastic and chemical production, methanol addresses both the demand for sustainable alternatives and the economic opportunities of a rapidly evolving market. A conversion pathway as described herein underscores a pivotal step towards a more eco-conscious, economically robust, and resource-efficient future.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system for mitigating pollution from hydraulic fracturing uses a laser reduction liquid (LRL) unit operable to receive flow back from a wellhead. The LRL unit includes a CO₂ filtration unit for filtering CO₂ from the flow back, a CO₂ purification unit for purifying the filtered CO₂, and a reaction unit including Q-driven ND:YAG laser and a reaction site at which a pulsed laser beam from the Q-driven ND:YAG laser is directed at the purified CO₂ in the presence of a photocatalyst to thereby convert the CO₂ into methanol and water.

In another embodiment,
a method for mitigating pollution from hydraulic fracturing includes filtering the CO2 from flow back of the hydraulic fracturing, purifying the filtered CO2, and directing a pulsed laser beam from a Q-driven ND:YAG laser at the purified CO2 in the presence of a photocatalyst to thereby convert the CO2 into methanol and water.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic diagram of a system for converting wellhead flowback carbon dioxide (CO2) to methanol using laser reduction in liquid (LRL) in accordance with certain embodiments.

FIG. 2 is a block diagram showing some details of the converter of system in accordance with certain embodiments.

FIG. 3 is a block diagram illustrating some details of a Q-switched Nd:YAG laser that can be used to convert wellhead flowback carbon dioxide to methanol using laser reduction in liquid (LRL) in accordance with certain embodiments.

FIG. 4 is a block diagram illustrating the user of a Q-switched Nd:YAG laser to convert wellhead flowback carbon dioxide to methanol using laser reduction in liquid (LRL) in accordance with certain embodiments.

### DETAILED DESCRIPTION

Embodiments of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the embodiments disclosed herein may be practiced without these specific details, or with details that are not described herein in the interest of clarity. Thus in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Embodiments in accordance with the present disclosure generally relate to mitigating adverse effects of hydraulic fracturing, and more particularly, to converting the CO₂ product thereof into methanol using laser reduction in liquids

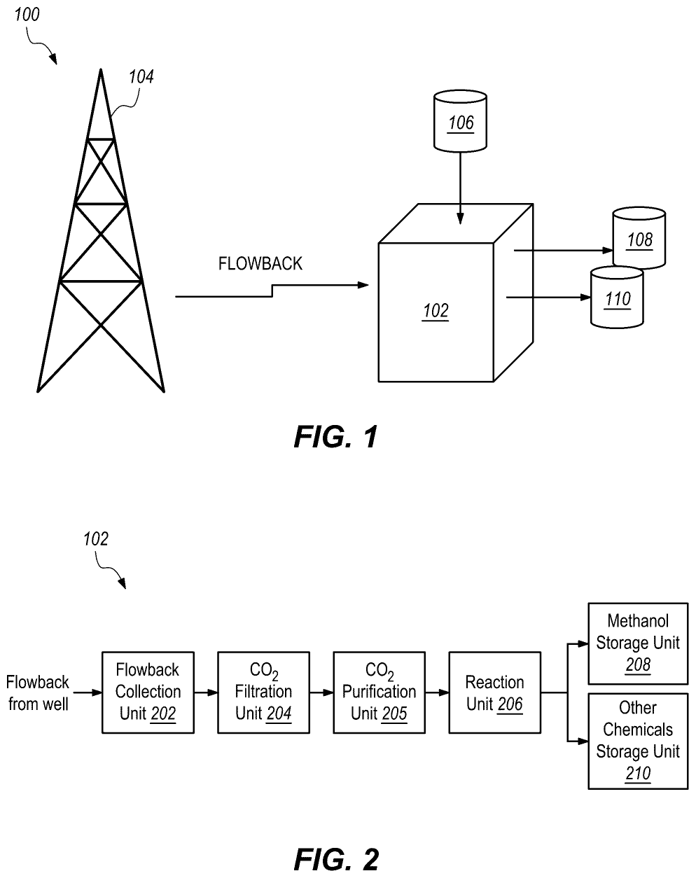

FIG. 1 is a schematic diagram of a system 100 for converting wellhead flowback carbon dioxide (CO2) to methanol using laser reduction in liquid (LRL) in accordance with certain embodiments. System 100 includes a converter 102 that may be portable and that may be disposed at the wellhead, and that is operable to receive wellhead flowback material from a hydrocarbon well 104, the material including CO₂ formation fluid from hydraulic fracturing for example and that may be in liquid or gaseous state, and mixed in with other material. Other feed material, such as water, may be supplied from a source 106 to facilitate the conversion operation discussed hereinbelow. The system 100 is operable to convert the CO₂ to water and methanol for storage in tanks 108 and 110, respectively, and possibly to output other materials, as detailed further below.

FIG. 2 is a block diagram showing some details of converter 102 of system 100. A flowback collection unit 202 receives the flowback from the well 104. A CO₂ filtration unit 204 filters the flowback material to attain filtered CO₂, which is collected and purified in purification unit 205 and then directed to a reaction unit 206 from which methanol is extracted, to be collected in a storage unit 208. Other chemicals are directed to an additional storage unit 210. More than one such additional storage units (not shown) may be present.

The converter 102 is portable and can be strategically positioned near the wellhead for example during fracturing operations. This obviates the need for extensive CO₂ transportation, effectively reducing associated costs and emissions. This mobility, paired with the system's environmental benefits, underscores its significance. By converting and repurposing CO₂ emissions directly near-wellhead while generating valuable products like methanol, the system 100 encapsulates a sustainable approach that can make a lasting positive impact on energy and CO₂ management.

The LRL process deployed by converter 102 involves focusing a high-intensity laser beam onto a liquid medium containing a dissolved CO₂ and other reactants. The CO₂ reduction mechanism is based on exciting CO₂ molecules absorbed in liquid medium (e.g., water) via laser energy to promote chemical reactions that lead to the reduction of CO₂ into different compounds. As the laser interacts with the CO₂ and water molecules, the bonds between its constituent atoms are broken due to the high energy imparted by the laser pulses. This results in the disintegration of elemental constituents or smaller molecular fragments.

The choice of laser type, reactants, and reduction reaction conditions plays an important role in determining the resultant produced chemical from the laser reduction process. Moreover, the specific laser parameters, including energy, pulse duration, and focus also control the degree of reduction, allowing for precise material removal and modification.

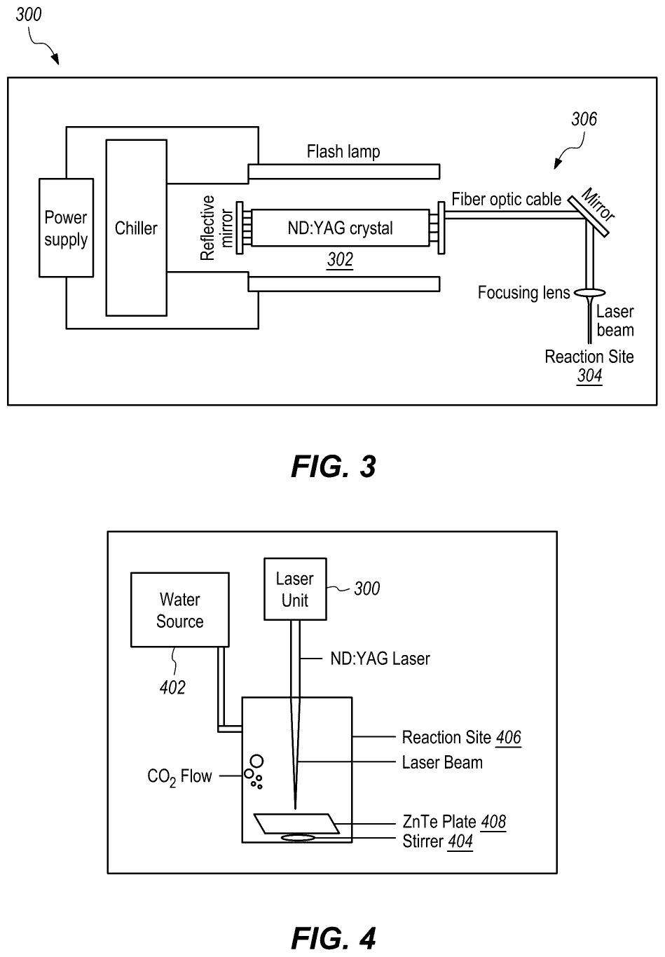

With reference to the example of FIG. 3, the utilized laser 300 may be a Q-switched Nd:YAG laser selected for its ability to generate high-energy, short-duration laser pulses and involve a Q-switching technique. The Q-switching technique, as opposed to continuous power mode, involves temporarily blocking the optical feedback within the laser cavity 302 to build up energy before releasing it in a single intense pulse directed to the reaction site 304 by way of optical system 306. Its high energy pulses allow for the accumulation of energy over a relatively long time period, followed by a rapid release to the reaction site 304. As a result, high-energy pulses are generated to effectively interact with and breakdown absorbed CO₂ and water molecules. The duration of the pulses generated by Q-switched Nd:YAG lasers is extremely short, typically in the nanosecond range. This short duration limits the heat generated during the interaction with the liquid, reducing the chances of thermal damage to the surrounding environment. In one example application, a pulse duration of about 10 ns is contemplated, with an energy of at least 700 mJ delivered at a wavelength of 532 nm. The beam size will be at the focus point, or Point of Maximum Intensity, calculated per the manufacturing specifications of the commercial laser used. Other types of lasers are also contemplated, as well as other transparent liquid media such as any catalyst with a bandgap of about 2.33 or less: Si, Ge, GaSe, CuAlTe2, AlAs, AlP, CuBr . . . etc.

In details, the efficiency of utilizing laser irradiation to convert CO₂ into methanol relies on the photochemical efficiency (Φ) of the photochemical reaction involved in the reduction unit between CO₂/H₂O and laser, which can be defined using the following equation:

$$Φ = \frac{Number of molecules transformed or products formed}{Number of absorbed photons ( {N}_{a b s} )} \qquad ( 1 )$$

In this equation, the key factor that can be enhanced by altering laser type is the “Number of absorbed photons.” Utilizing pulsed lasers in CO₂ conversion process can increase the intensity of absorbed photons due to the following reasons:
Photon flux: Pulsed lasers can deliver a high number of photons in a very short time, resulting in a higher photon flux. This means that within the short pulse duration, a greater number of photons can be absorbed by the reactants, leading to a more efficient photoexcitation process to reduce CO₂/H₂O molecules.
Pulse duration: Pulsed lasers have extremely short pulse durations, often in the femtosecond to nanosecond range. During this brief time, a significant amount of laser energy is concentrated, increasing the probability of photon absorption by the reactants. This brief, intense burst of photons can enhance the efficiency of the photochemical reaction.
Peak power: Pulsed lasers can achieve extremely high peak powers due to their short pulse durations. Higher peak power results in a more concentrated energy delivery per pulse, which can lead to greater photon absorption and, consequently, enhanced photochemical efficiency.

In certain embodiments, zinc telluride (ZnTe) is selected as the catalyst for the CO₂ conversion process. It is a semiconductor material. This semiconductor possesses several advantages that promote the efficacy of CO₂ reduction applying Q-switched Nd:YAG laser, including:
It has a bandgap of 2.26 eV at 25° C. that perfectly aligns with the Q-switched Nd:YAG laser wavelength (532 nm). This precise matching ensures maximum absorption of the laser light, leading to highly efficient photoexcitation of the catalyst. This focused excitation allows for better utilization of the laser energy in driving the CO₂-to-methanol conversion.
Possess photocatalytic activity to generate electron-hole pairs that can participate in photochemical reactions upon impingement by the laser.
Has selective absorption property where it only absorbs 532 nm light which minimize energy wastage on unwanted wavelengths leading to improved overall efficiency of the photochemical reaction.
The photostability of ZnTe maintains its photocatalytic activity under the influence of 532 nm laser light, ensuring stable and consistent performance over extended reaction times.
The tailored excitation of ZnTe by the laser's wavelength reduces the likelihood of side reactions, leading to a higher selectivity for methanol production.

In accordance with certain embodiments, any narrow band gap semiconductors that have a band gap energy compatible with 532 laser wavelengths can be used.

Referring again to FIG. 2, the converter 102 includes components such as flowback stream collection unit 202, filtration unit 204, purification unit 205, LRL reaction unit 206 (can include water source, electric unit, laser, water source, catalyst, and stirrer), and methanol storage unit 208. In accordance with certain embodiments, performance of the following method by converter 102 contemplated: 1) at flowback stream collection unit 202 the flowback stream that includes hydrocarbons, water, vapors, and CO₂ is collected; (2) in the filtration unit 204, the CO₂ is separated from the stream using specific membrane (not shown) and then transferred to the purification unit 205. (3) At the purification unit 205, the CO₂ undergoes a purification step to eliminate impurities and ensure an optimized input stream for subsequent conversion reactions. (4) The refined CO₂ is transferred to reaction unit 206 and mixed with water at room temperature and then exposed to laser power. (5) The resulting reaction products, including methanol, transfer through pipeline to distinct collection tanks 208, 210 based on their specific type. This segregation streamlines efficient separation and collection, facilitating subsequent processing and utilization.

In certain embodiments, LRL reaction unit tank 206 can be made from quartz to optimize the transmission of laser energy by capitalizing on the material's inherent optical transparency. This engineering choice mitigates self-attenuation and fosters an environment conducive to efficient CO₂ reduction.

In certain embodiments, and with reference to FIG. 4, the processes at LRL reaction unit 206 includes a liquid medium (water). This medium facilitates laser ablation and provides the necessary platform for chemical interactions to occur. Thus water from water source 402 enhances the efficacy of CO₂ particles' interaction with laser pulses, thereby promoting a more effective conversion process. By using a stirrer (404), CO₂ and water are mixed to guarantee the homogeneity of aqueous solution. At same time of stirring, the Nd:YAG laser 300 operates as a single coherent beam to ensure the exhaustive reaction with CO₂ and H₂O particles. The Nd:YAG laser 300 is coupled to a reliable power supply (FIG. 3) to emit high-energy pulses from the top side in direct vertical direction into the reaction site 406. These pulses enable precise laser ablation and controlled reduction reactions, enabling the CO₂-to-methanol conversion process. Moreover, the photocatalyst plate 408 (includes ZnTe) appears in its solid form, the plate will be placed perpendicular to the laser beam direction.

In certain embodiments, the chemical reactions inside the LRL reaction unit 106 are as following: First, the photocatalyst ZnTe absorbs a photon of sufficient energy leading to promote electrons excitation from valence band to the conduction band, creating an electron-hole pair, which results in the creation of thermal energy.

$$ZnTe + hv \to {e}^{-} + {h}^{+} \qquad ( 2 )$$

$${e}^{-} + {h}^{+} \to thermal energy \qquad ( 3 )$$

Second, the CO₂/H₂O excitation process begins with the activation of CO₂ and water molecules using a Nd:YAG laser. The laser excites the CO₂ molecules to higher energy states, making them more reactive, this can be represented as:

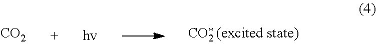

Third, the excited CO₂ molecules adsorb and attach to the surface of the ZnTe catalyst via Lewis acid-base interactions or another surface chemistry. The adsorption can be represented as:

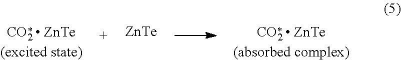

Fourth, once the CO₂ molecules are adsorbed on the ZnTe surface the hydrogenation can occur. This involves the reaction between CO₂ and hydrogen (H₂) molecules that are found in the reaction medium, with the help of the ZnTe catalyst.

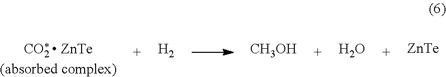

Here,

$${CO}_{2}^{*} \cdot ZnTe$$

represents the adsorbed

$${CO}_{2}^{*}$$

on the catalyst surface, and CH₃OH is the desired product, methanol.

Fifth, after the hydrogenation reaction, the resultant methanol and water molecules are desorbed from the ZnTe surface by heat produced from the laser, as:

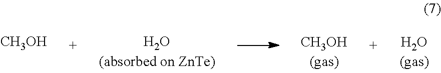

In this complex process, the Nd:YAG laser serves to activate the CO₂ molecules, making them more reactive and facilitating the initial adsorption onto the ZnTe surface. The ZnTe catalyst plays a crucial role in providing sites for adsorption, activation, and facilitating the hydrogenation reaction.

The advantages of the disclosed arrangement are multifold. It can be utilized to reduce the concentration of CO₂ in the atmosphere using a sustainable and environmentally friendly approach that addresses carbon emission and water scarcity, providing economic and health concerns in terms of global warming and sustainability. The LRL approach is particularly valuable when accuracy and control over the reduction process are required, which is critical to the conversion of CO₂. The duration of the pulses generated by Q-switched Nd:YAG lasers is extremely short, typically in the nanosecond range. This short duration limits the heat generated during the interaction with the liquid, reducing the chances of thermal damage to the surrounding environment. In the context of using LRL, self-attenuation can affect the efficiency and accuracy of the process. Q-switched Nd:YAG lasers offer advantages in terms of self-attenuation compared to continuous-wave lasers or longer pulse lasers. This is because the short pulse duration characteristic of Q-switched lasers limits the amount of time during which the emitted radiation is absorbed by the material being processed. As a result, self-attenuation is reduced, allowing more of the laser energy to effectively interact with the material without significant loss due to absorption.

The short and intense pulses of a Q-switched Nd:YAG laser allow the laser energy to penetrate deeper into the material before it has a chance to be significantly absorbed by the material itself. This is especially important when working with liquid samples containing chemical compounds such as the method set forth herein, as it ensures that the laser energy can reach the desired target with minimal attenuation, leading to more efficient and accurate reduction processes.

The system's portability, strategically positioning it near wellheads during fracking operations, extends beyond convenience. By curbing the need for extensive CO₂ transportation, the system effectively reduces associated costs and emissions. This mobility, paired with the system's environmental benefits, underscores its significance. By converting and repurposing CO₂ emissions directly near-wellhead while generating valuable products like methanol, the system encapsulates a sustainable approach poised to make a lasting impact on energy and CO₂ management.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The present disclosure is also directed to the following exemplary embodiments, which can be practiced in any combination thereof:
Embodiment 1: A combination of claims 1-8
Embodiment 2: A combination of claims 9-16

The invention claimed is:

1. A system for mitigating pollution from hydraulic fracturing comprising:
a laser reduction liquid (LRL) unit operable to receive flow back from a wellhead, the LRL unit including:
a CO₂ filtration unit for filtering CO₂ from the flow back,
a CO₂ purification unit for purifying the filtered CO₂, and
a reaction unit including Q-driven ND:YAG laser and a reaction site at which a pulsed laser beam from the Q-driven ND:YAG laser is directed at the purified CO₂ in the presence of a photocatalyst to thereby convert the CO₂ into methanol and water.

2. The system of claim 1, wherein the pulsed laser beam has a wavelength of about 532 nm.

3. The system of claim 1, wherein the photocatalyst has a bandgap of about 2.26 eV at 25° C.

4. The system of claim 1, wherein the photocatalyst comprises ZnTe.

5. The system of claim 1, wherein the photocatalyst has a bandgap of about 2.33 or less.

6. The system of claim 1, wherein the photocatalyst is selected from: Si, Ge, GaSe, CuAlTe2, AlAs, AlP, and CuBr.

7. The system of claim 1, wherein the reaction site includes a stirrer for stirring the purified CO₂.

8. The system of claim 7, further including a water source providing water with which the purified CO₂ is mixed.

9. A method for mitigating pollution from hydraulic fracturing comprising:
filtering the CO₂ from flow back of the hydraulic fracturing;
purifying the filtered CO₂; and
directing a pulsed laser beam from a Q-driven ND:YAG laser at the purified CO₂ in the presence of a photocatalyst to thereby convert the CO₂ into methanol and water.

10. The method of claim 9, wherein the pulsed laser beam has a wavelength of about 532 nm.

11. The method of claim 9, wherein the photocatalyst has a bandgap of about 2.26 eV at 25° C.

12. The method of claim 9, wherein the photocatalyst comprises ZnTe.

13. The method of claim 9, wherein the photocatalyst has a bandgap of about 2.33 or less.

14. The method of claim 9, wherein the photocatalyst is selected from: Si, Ge, GaSe, CuAlTe2, AlAs, AlP, and CuBr.

15. The method of claim 9, further comprising stirring the purified CO₂.

16. The method of claim 15, further comprising adding water to the purified CO₂.
